(19) United States
(12) Patent Application Publication
(10) Pub. No.: US 2009/0035513 A1
(43) Pub. Date: Feb. 5, 2009

(54) TETHERED NANORODS

(76) Inventors: Michael Jeremiah Bortner, Blacksburg, VA (US); Victor Vincent Baranauskas, Christiansburg, VA (US); Ben David Poquette, Blacksburg, VA (US)

Correspondence Address: SHERR & VAUGHN, PLLC, 620 HERNDON PARKWAY, SUITE 200, HERNDON, VA, 20170, US

(21) Appl. No.: 12/058,238

(22) Filed: Mar. 28, 2008

Related U.S. Application Data
(60) Provisional application No. 60/884,540, filed on Mar. 28, 2007.

(51) Int. Cl. B32B 3/10; B32B 3/00

(52) U.S. Cl. 428/131; 428/337

(57) ABSTRACT

An apparatus (and a method of making the apparatus) that includes a substrate (e.g. a conductive and/or non-conductive material) and a plurality of nanorods (e.g. having a diameter less than 1000 nanometers) tethered to the substrate. The nanorods may be formed by forming the substrate on a mold (e.g. an inorganic membrane having a plurality of pores) and then depositing material on the substrate inside of the mold. Since the deposited material has a relatively low interaction with the mold and a relatively high interaction with the substrate, nanorods may be formed. After the nanorods are formed inside of the mold, the nanorods remain tethered to the substrate and the mold may be removed.

The present application claims priority to U.S. Provisional Patent Application No. 60/884,540 (filed Mar. 28, 2007), which is hereby incorporated by reference in its entirety.

### BACKGROUND

Nanorods are nanoscopic rods or fibers that have an aspect ratio (e.g. diameter versus length) greater than, less than, or equal to one, but relatively small overall dimensions (e.g. under 1000 nanometers). Nanorods have been relatively difficult to fabricate. The choices of materials for nanorods has been limited. Nanorods have been fabricated such that they are not tethered to a surface or substrate. These limitations further limit the practicality and implantation of nanorods.

### SUMMARY

Embodiments relate to an apparatus (and a method of making the apparatus) that includes a substrate (e.g. a conductive and/or non-conductive material) and a plurality of nanorods tethered to the substrate. In embodiments, the nanorods may be synthesized by forming the substrate on a mold (e.g. a membrane having a plurality of pores) and then depositing material on the substrate inside of the mold. In embodiments, since the deposited material has a relatively low interaction with the mold and a relatively high interaction with the substrate, nanorods may be formed. After the nanorods are formed inside of the mold, the mold may be removed (e.g. by chemical or mechanical means) in a manner allowing the nanorods to remain tethered to the substrate.

In embodiments, the nanorods may be fabricated by self assembly or other methods. Due to the relative flexibility of materials that may be used to fabricate nanorods and/or the ability of nanorods to be tethered to a substrate, many applications of nanorods may be implemented, in accordance with embodiments. For example, tethered nanorods may be implemented in high surface area applications (e.g. biosensors, heat sinks, or catalytic applications). As another example, tethered nanorods may be implemented in surface-to-surface conformation (e.g. gecko feet applications). In embodiments, self assembled (or partially self assembled nanorods) may have multi-functionality (e.g. adhesion functions, mechanical functions, thermal functions, electrical functions, conduction function, and/or optical functions). Further, in embodiments, tethered nanorods may be fabricated to have substantially predetermined dimensions (e.g. length) based on a self assembly process.

### DRAWINGS

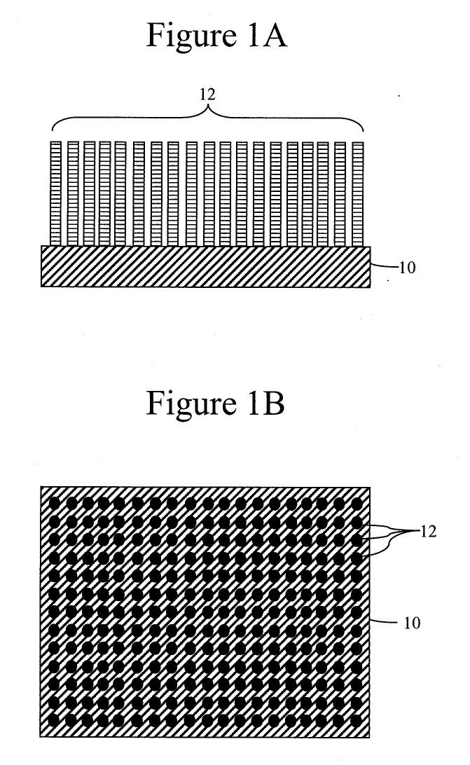

Example FIGS. 1A and 1B illustrates a plurality of nanorods tethered to a substrate, in accordance with embodiments.

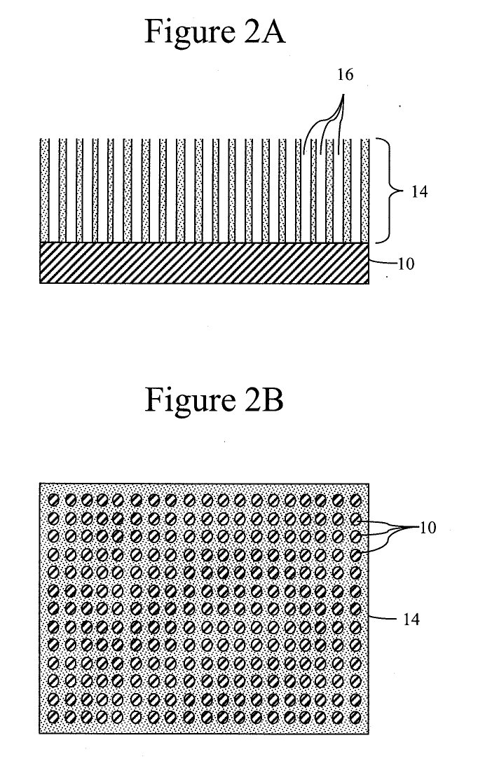

Example FIGS. 2A and 2B illustrate a substrate formed on a mold, in accordance with embodiments.

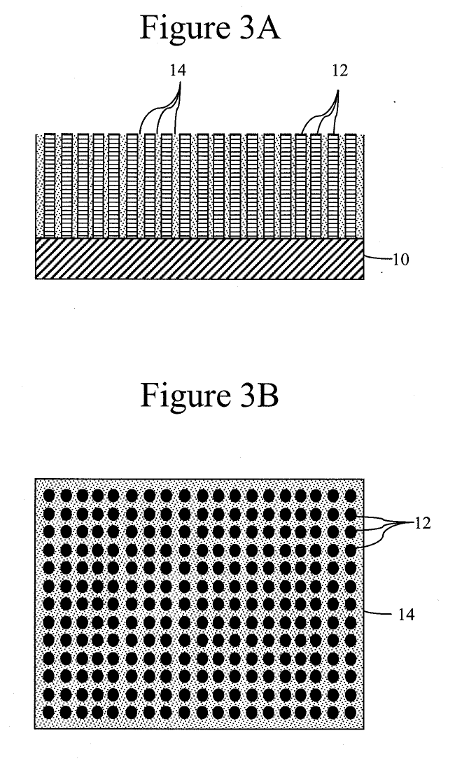

Example FIGS. 3A and 3B illustrate nanorods tethered to a substrate inside a mold, in accordance with embodiments.

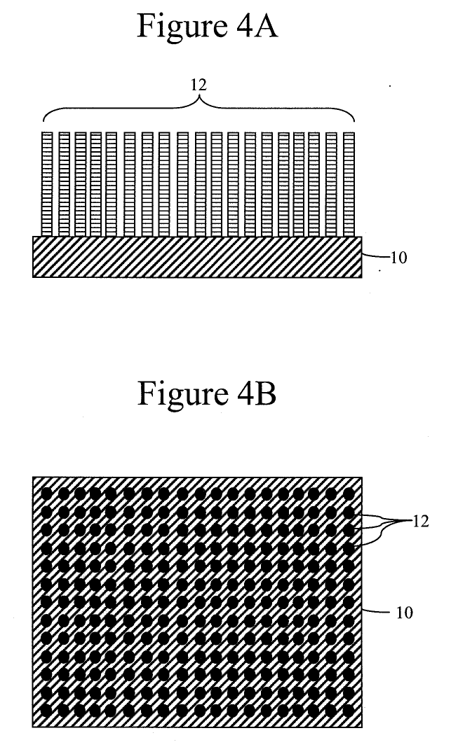

Example FIGS. 4A and 4B illustrate nanorods tethered to a substrate after a mold has been removed, in accordance with embodiments.

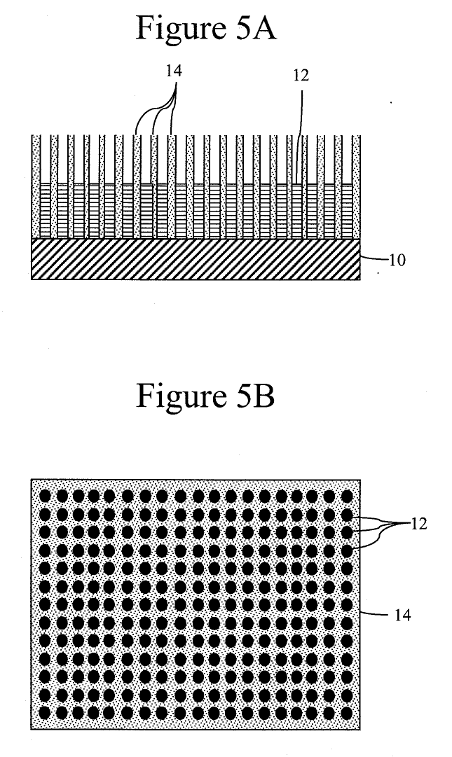

Example FIGS. 5A and 5B illustrate nanorods that are formed through a portion of the thickness of a mold, in accordance with embodiments.

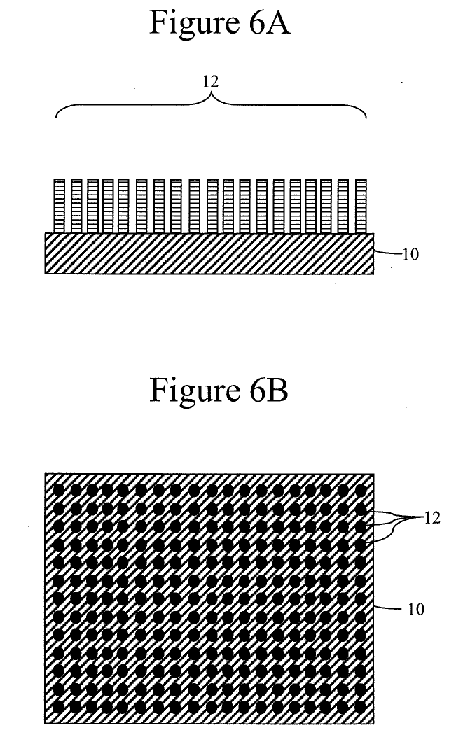

Example FIGS. 6A and 6B illustrate nanorods that were formed through a portion of the thickness of a mold after the mold is removed, in accordance with embodiments.

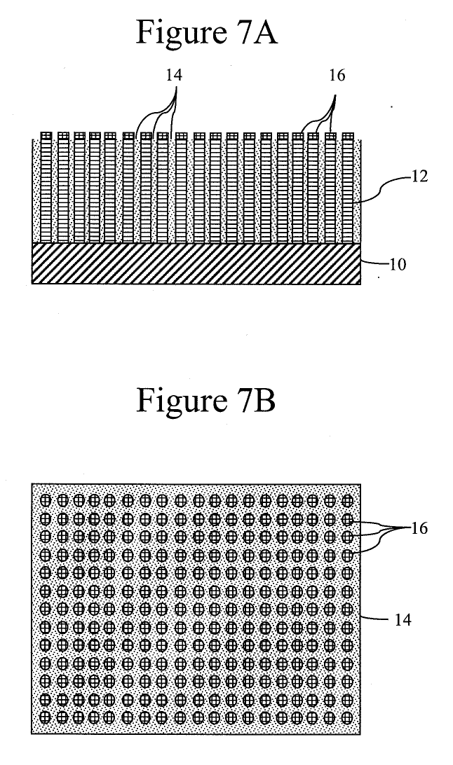

Example FIGS. 7A and 7B illustrate nanorods in a mold with the tips functionalized, in accordance with embodiments.

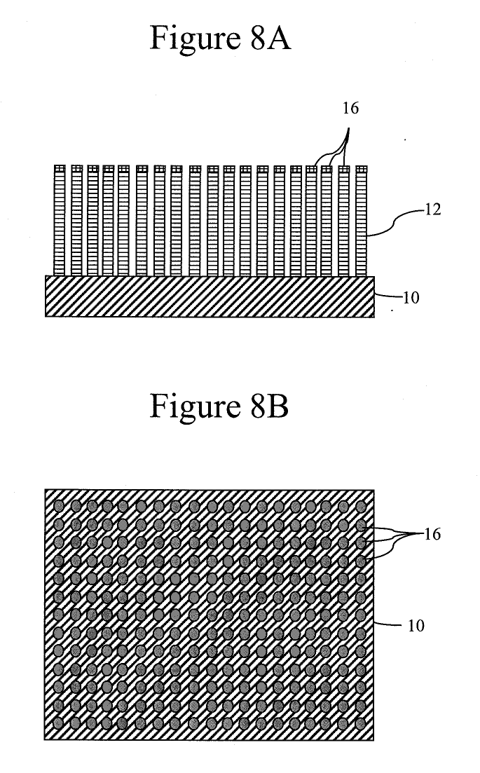

Example FIGS. 8A and 8B illustrate nanorods with the tips functionalized after removal of a mold, in accordance with embodiments.

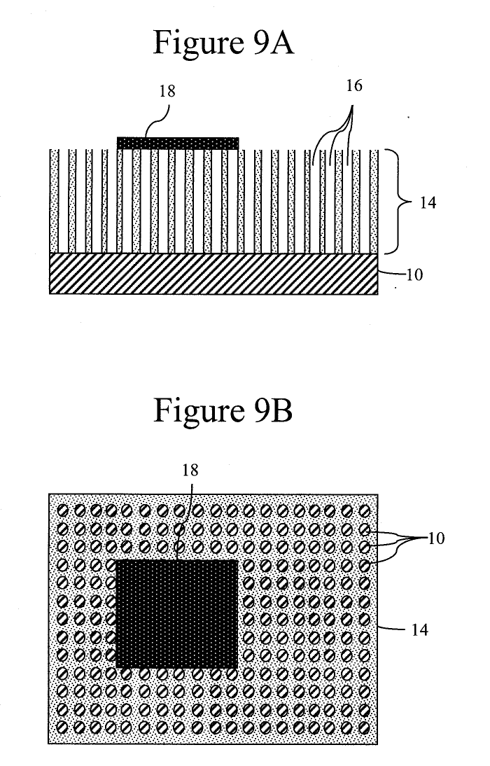

Example FIGS. 9A and 9B illustrate a mask formed over a mold, in accordance with embodiments.

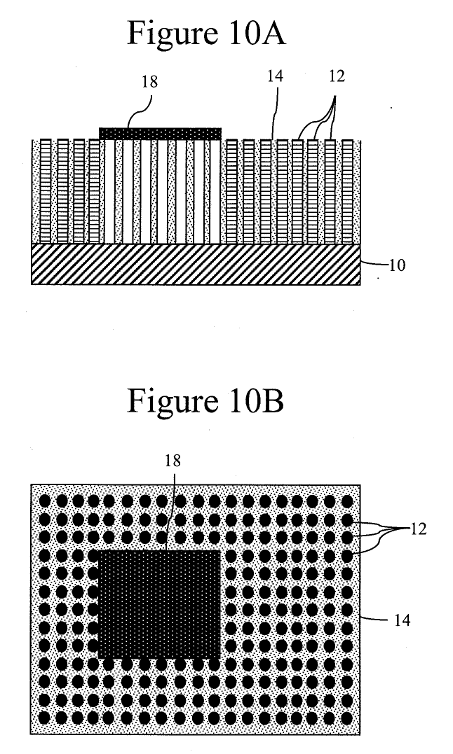

Example FIGS. 10A and 10B illustrate nanorods formed in pores of a mold that are not masked, in accordance with embodiments.

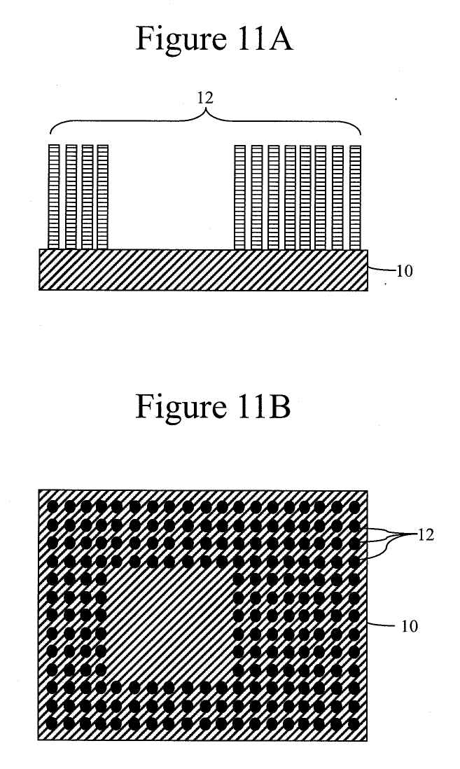

Example FIGS. 11A and 11B illustrate nanorods tethered to a substrate in areas that were not masked, in accordance with embodiments.

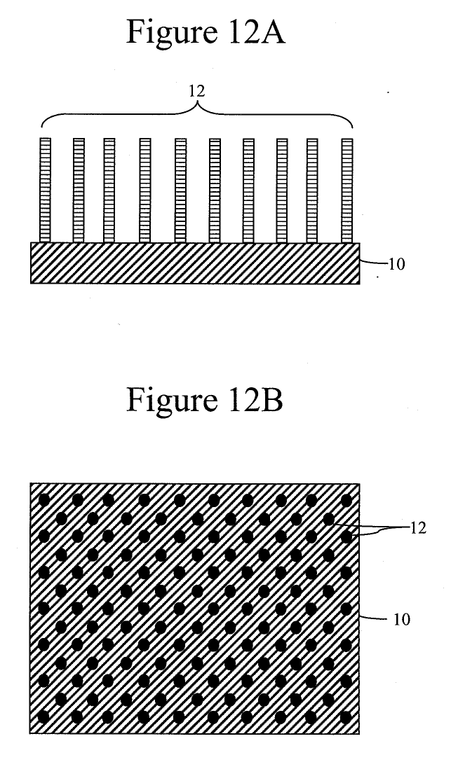

Example FIGS. 12A and 12B illustrate nanorods that remain after post processing that reduces the density of nanorods, in accordance with embodiments.

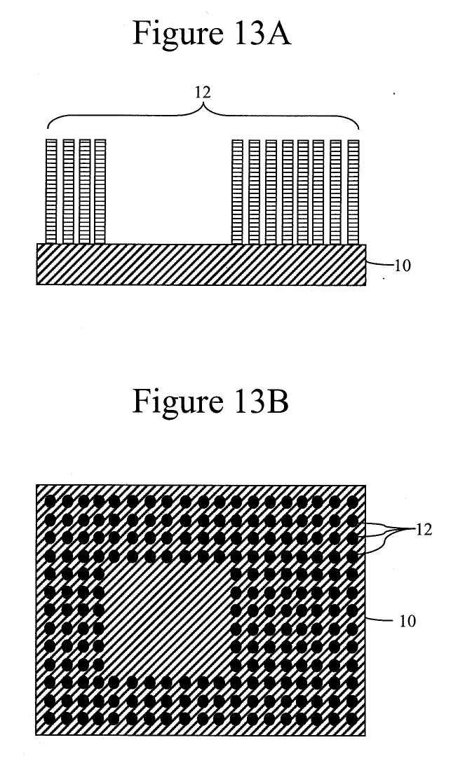

Example FIGS. 13A and 13B illustrate nanorods that remain after post processing what remove nanorods in geometric regions, in accordance with embodiments.

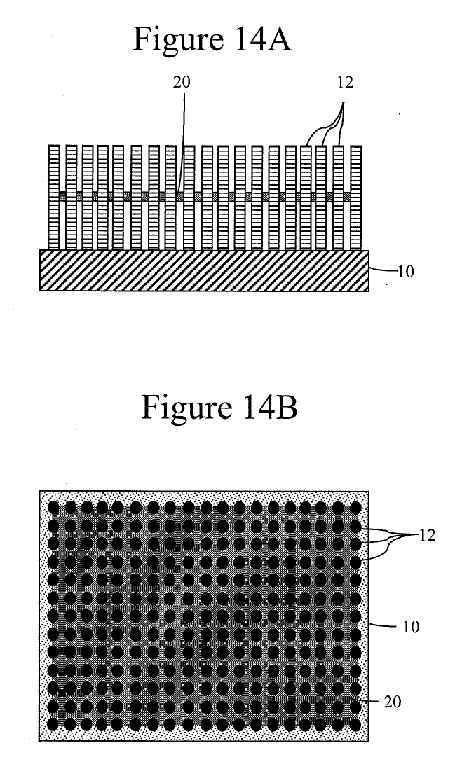

Example FIGS. 14A and 14B illustrate nanorods that are post processed to form selective functionalization of nanorods, in accordance with embodiments.

### DESCRIPTION

Example FIGS. 1A and 1B illustrates a plurality of nanorods 12 tethered to a substrate 10, in accordance with embodiments. FIG. 1A illustrates a cross-sectional view of nanorods 12 tethered to substrate 10. FIG. 1B illustrates a top view of nanorods 12 tethered to substrate 10. In embodiments, nanorods may have a diameter less than approximately 1000 nanometers. However, embodiments may relate to nanorods that have a diameter greater than 1000 nanometers. In embodiments, nanorods may be nanofibers.

Substrate 10 represents a broad class of surfaces. For example, substrate 10 may be a conductive material or a non-conductive material. Substrate 10 may be part of a previously existing structure. The materials of substrate 10 and nanorods 12 may be such that nanorods 12 can be formed on substrate 10 and tethered (e.g. bonded) to substrate 10. In embodiments, the materials of substrate 10 and nanorods 12 may be the same or different materials. A collection of nanorods 12 on substrate 10 may be referred to as a nanorod forest or nanorod array.

The spatial distribution and dimensions of nanorods illustrated in all of the Figures is intended for illustration purposes only. One of ordinary skill in the art would appreciate other dimensions, in accordance with embodiments.

Example Figure Sets 2-4 illustrate a fabrication process of nanorods 12 tethered to substrate 10, in accordance with embodiments. Example FIGS. 2A and 2B illustrate a substrate 10 formed on a mold 14, in accordance with embodiments. FIG. 2A illustrates a cross-sectional view of mold 14 formed on substrate 10. FIG. 2B illustrates a top view of mold 14 formed on substrate 10. In embodiments, a substrate 10 may be formed on a mold 14 by generally attaching the substrate 10 and mold 14 together. For example, substrate 10 may be part of a preexisting structure and mold 14 is attached to substrate 10. In embodiments, substrate 10 may actually be formed on mold 14 (e.g. by a material deposition method).

As illustrated in example FIG. 2A, mold 14 may include a plurality of pores 16. Pores 16 may extend through the entire thickness of the mold 14 to expose a surface of substrate 10 (as shown in example FIG. 2B). In embodiments, mold 14 may be an inorganic membrane. For example, mold 14 may be an Anodisc membrane made by Whatman. However, other types of molds may be used, in accordance with embodiments.

Example FIGS. 3A and 3B illustrate nanorods tethered to a substrate inside a mold, in accordance with embodiments. FIG. 3A illustrates a cross-sectional view of nanorods 12 tethered to substrate 10 formed in pores of mold 14. FIG. 3B illustrates a top view of nanorods 12 formed in pores of mold 14. As illustrated in example FIG. 3A, pores 16 of mold 14 may be filled with material to form nanorods 12 tethered to substrate 10, in accordance with embodiments. During a material deposition process of forming nanorods 12, deposited material of the nanorods 12 may bond or tether to substrate 10 at the bottom of pores 16 of mold 14 and build upwards from the bottom of the pore (i.e. the section of the pores closest to the substrate) to the pore opening. In embodiments, materials may be chosen such that deposited nanorod material interacts with the substrate (and subsequently deposited nanorod material), but does not substantially interact with sidewalls of pores 16. Accordingly, nanorods 12 may be formed or grown using substrate 10 as a base and the sidewalls of pores 16 to mold the shape of nanorods 12.

In embodiments, when depositing material that forms the nanorods 12, external stimulation may be utilized to promote contact and/or interaction with the deposited nanorod material and substrate 10. For example, electrical stimulation may be used to promote interaction (e.g. electrochemical deposition and/or electrophoresis). For example, applied pressure deposition (e.g. applied water and/or air pressure) may be used to promote interaction.

In embodiments, nanorods 12 may be formed by electrochemical deposition and/or electrophoresis. In electrochemical deposition and/or electrophoresis embodiments, substrate 10 and/or nanorods 12 may include a conductive material. A voltage potential and/or electrical current may be applied to a conductive substrate to promote migration of conductive material to be formed on substrate 10 inside pores 16. The length of nanorods 12 may be formed to a substantially predetermined length by control of the parameters of an electrochemical deposition and/or electrophoresis process, in accordance with embodiments.

In embodiments, nanorods 12 may be formed by a self assembly process. U.S. patent application Ser. No. 10/774,683 (filed Feb. 10, 2004 and titled “RAPIDLY SELF-ASSEMBLED THIN FILMS AND FUNCTIONAL DECALS”) is hereby incorporated by reference in its entirety. U.S. patent application Ser. No. 10/774,683 discloses self-assembly of nano-particles and nano-layers, in accordance with embodiments. In embodiments, the size (i.e. diameter or substantial diameter) of the nano-particles may be less than approximately 1000 nanometers. In embodiments, the size of the nano-particles may be less than approximately 50 nanometers. In embodiments, nano-particles may be gold and/or gold clusters. However, in other embodiments, nano-particles may be other metals (e.g. silver, palladium, copper, or other similar metal) and/or metal clusters. In embodiments, nano-particles may include metals, metal oxides, inorganic materials, organic materials, ceramics, and/or mixtures of different types of materials. In embodiments, nano-particles may be semiconductor materials.

Through self assembly, nano-particles may be substantially uniformally and/or spatially dispersed during deposition to form a self assembled film, in accordance with embodiments. In embodiments, a self assembled film may be deposited in pores 16 to formed a layered nanorod 12. The self assembly of nano-particles may utilize electrostatic and/or covalent bonding of the individual nano-particles to a host layer (e.g. a linking agent material layer and/or a flexible base material). A host layer (e.g. substrate 10) may be polarized in order to allow for the nano-particles to bond to the host layer, in accordance with embodiments. Since the deposition of the nano-particles may be dependent on individual bonding of the nano-particles to the host layer, a nano-particle material layer may have a thickness that is approximately the diameter of the individual nano-particles. Through a self-assembly deposition method, nano-particles that do not bond to a host layer may be removed, so that a nano-particles material layer is formed that is relatively uniform in thickness and material distribution.

Linking agent material layer(s) may be a material that is capable of covalently and/or electrostaticly bonding to nano-particles, in accordance with embodiments. U.S. patent application Ser. No. 10/774,683 (which is incorporated by reference above) discloses examples of materials which may be included in linking agent material layer(s). Linking agent material layer(s) may include polymer material. In embodiments, the polymer material may include poly(urethane), poly(etherurethane), poly(esterurethane), poly(urethane)-co-(siloxane), poly(dimethyl-co-methylhydrido-co-3-cyanopropyl, methyl) siloxane, and/or other similar materials. Linking agent material layer(s) may include materials that are polarized, in order for bonding with nano-particles, in accordance with embodiments.

In embodiments, since self assembly of nanorods 12 can form multi-layered nanorods having substantially predetermined thickness and material attributes, nanorods 12 may be fabricated with multi-functional attributes. For example, nanorods 12 may have various combinations of adhesion functions, mechanical functions, thermal functions, electrical functions, conduction functions, and/or optical functions. For example, nanorods 12 may be utilized as a heat sink due to high surface area and heat conduction attributes of engineered nanorods. Those skilled in the art would appreciate other applications, in accordance with embodiments.

In embodiments, nanorods 12 may be formed by delivering material of the nanorods to the substrate using a liquid as a delivery agent. For example, in electrochemical deposition and/or electrophoresis embodiments, conductive materials may be incorporated in a liquid that fills pores 16. For example, in a self assembly process, materials to be deposited may be dispersed in a liquid. Embodiments also relate to material deposition processes aside from electrochemical deposition, eletrophoretics, and/or self-assembly or a combination of deposition methods.

Example FIGS. 4A and 4B illustrate nanorods 12 tethered to a substrate 10 after a mold 14 has been removed, in accordance with embodiments. FIG. 4A illustrates a cross-sectional view of nanorods 12 tethered to substrate 10 after a mold 14 has been removed. FIG. 4B illustrates a top view of nanorod 12 tethered to substrate 10 after a mold 14 has been removed. After nanorods 12 have been formed using mold 14 to define the shape of nanorods 12, mold 14 may be removed, in accordance with embodiments. In embodiments, mold 14 may be removed by being dissolved in a liquid. For example, if mold 14 is an Anodisc membrane, it may be dissolved in a mixture of potassium hydroxide, water, and methanol. However, other methods of removing mold 14 may be appreciated, in accordance with embodiments.

Example FIGS. 5A and 5B illustrate nanorods that are formed through a portion of the thickness of a mold, in accordance with embodiments. FIG. 5A illustrates a cross-sectional view of nanorods 12 tethered to substrate 10 in mold 14, where the nanorods 12 are formed through a portion of the thickness of mold 14. FIG. 5B illustrates a top view of nanorods 12 tethered to substrate 10 in mold 14, where the nanorods 12 are formed through a portion of the thickness of mold 14. Example FIGS. 6A and 6B illustrate nanorods that were formed through a portion of the thickness of a mold after the mold is removed, in accordance with embodiments. In embodiments, the length of nanorods 12 may be control based on a deposition process. Accordingly, the length of nanorods 12 is does not necessarily have to comply with the thickness of mold 14, in accordance with embodiments.

Example FIGS. 7A and 7B illustrate nanorods 12 in a mold with the tips 16 functionalized, in accordance with embodiments. After nanorods 12 have been formed through the thickness of mold 14, the tips 16 of nanorods 12 may be further processed, in accordance with embodiments. Further processing may including further self-assembly processes, electrochemical deposition, eletrophoretics, or other material deposition processes. Additional processing may provide an additional function or functions, such as adhesion functions, mechanical functions, thermal functions, electrical functions, conduction functions, and/or optical functions. For example, processing of the tips 16 of nanorods 12 may provide for components in photonic meta-materials and/or RF meta-materials (e.g. cloaking materials). Processing the tips 16 of nanorods 12 may be most practically accomplished prior to removal of mold 14, as the tip 16 may be part of a substantially flat surface. Those skilled in the art would appreciate different processes and functions that may be performed and/or attributed to tips 16, in accordance with embodiments. Example FIGS. 8A and 8B illustrate nanorods 12 with the tips 16 functionalized after removal of a mold 14, in accordance with embodiments. In embodiments, a second substrate may be formed over mold 14 and nanorods 12 prior to removal of mold 14.

Example Figure Sets 9-11 illustrate using a mask 18 on mold 14, in accordance with embodiments. Example FIGS. 9A and 9B illustrate a mask 18 formed over a mold 14 prior to forming nanorods in mold 14, in accordance with embodiments. Mask 18 may be utilized to control geometries of nanorods tethered to substrate 10. As illustrated in example FIGS. 10A and 10B, nanorods 12 are formed in pores of mold 14 that are not masked while masked pores remain open, in accordance with embodiments. As illustrated in example FIGS. 11A and 11B, nanorods 12 are tethered to a substrate 10 in areas that were not masked in a predetermine geometry, in accordance with embodiments. The shape, scale, and distribution of mask 18 are intended for illustration purposes only. Those skilled in the art would appreciate other shapes, patterns, and/or distribution of masks

In embodiments, nanorods 12 may be processed after being formed. Example FIGS. 12A and 12B illustrate nanorods that remain after post processing that reduces the density of nanorods, in accordance with embodiments. Example FIGS. 13A and 13B illustrate nanorods that remain after post processing that remove nanorods in geometric regions, in accordance with embodiments. In embodiments, post processing may include deposition of material on the nanorods (e.g. by self-assembly). For example, self-assembly may be performed to selectively interact with different previously self-assembled layers in the nanorods.

Example FIGS. 14A and 14B illustrate nanorods that are post processed to form selective functionalization of nanorods, in accordance with embodiments. For example, in embodiments with multilayered self-assembled nanorods 12, post processing may form chemical and/or mechanical bridges 20 between individual nanorods. One of ordinary skill in the art will appreciate other selective functionalization in accordance with embodiment,

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus comprising:
a substrate; and
a plurality of nanorods tethered to the substrate.

2. The apparatus of claim 1, wherein said plurality of nanorods each have a diameter less than approximately 1000 nanometers.

3. The apparatus of claim 1, wherein the substrate comprises at least one of:
a conductive material; and
a non-conductive material.

4. The apparatus of claim 1, wherein said plurality of nanorods are formed by:
forming the substrate on a mold;
depositing material on the substrate inside a plurality of pores of the mold to form said plurality of nanorods.

5. The apparatus of claim 4, wherein the mold and/or substrate are retained to provide additional functionality or structure.

6. The apparatus of claim 4, wherein said plurality of nanorods are formed by masking at least a portion of said plurality of pores prior to said depositing material on the substrate inside the plurality of pores.

7. The apparatus of claim 6, wherein said masking at least one of:
selectively controls a density of said plurality of nanorods; and
selectively creates a substantially predetermined geometry of said plurality of nanorods.

8. The apparatus of claim 4, wherein the material deposited inside the plurality of pores of the mold has a relatively low interaction with the mold and a relatively high interaction with the substrate.

9. The apparatus of claim 8, wherein said relatively high interaction comprises electrical attraction between the deposited material and the substrate.

10. The apparatus of claim 9, wherein the electrical attraction between the deposited material is caused by at least one of an electrochemical deposition process and a electrophoretic process.

11. The apparatus of claim 8, wherein said relatively high interaction comprises self assembly of materials.

12. The apparatus of claim 11, wherein self assembly of material is configured to form nanorods with at least one of a substantially predetermined length and substantially predetermined physical properties.

13. The apparatus of claim 4, wherein said plurality of nanorods are formed by removing the mold after said plurality of nanorods are formed.

14. The apparatus of claim 13, wherein:
the mold is an inorganic membrane;
the plurality of pores extend through the inorganic membrane; and
said removing the mold comprises dissolving the inorganic membrane into a solution.

15. The apparatus of claim 13, wherein said plurality of nanorods are processed after said removing the mold.

16. The apparatus of claim 15, wherein said plurality of nanorods are processed after said removing the mold by at least one of:
selectively removing at least one of said plurality of nanorods from the substrate to reduce density of said plurality of nanorods; and
selectively removing at least one of said plurality of nanorods from the substrate to create a substantially predetermined geometry of said plurality of nanorods.

17. The apparatus of claim 4, wherein said depositing material on the substrate inside the plurality of pores of the mold comprises applied pressure deposition.

18. The apparatus of claim 4, wherein said depositing material on the substrate inside the plurality of pores of the mold comprises using an liquid host to deliver the material to be deposited.

19. The apparatus of claim 4, wherein at least one of said plurality of nanorods has a length that extends the length of at least one of said pores of the mold.

20. The apparatus of claim 19, wherein at least one tip of at least one of said plurality of nanorods is processed prior to removing the mold.

21. The apparatus of claim 20, wherein said at least one tip is processed to provide at least one of the following functions:
adhesion functions;
mechanical functions;
thermal functions;
electrical functions;
conduction functions; and
optical functions.

22. The apparatus of claim 4, wherein at least one of said plurality of nanorods has a length that extends a portion of the length of at least one of said pores of the mold.

23. The apparatus of claim 1, wherein at least one of said plurality of nanorods is a multilayered nanorod.

24. The apparatus of claim 23, wherein said multilayered nanorod is a multifunctional nanorod.

25. The apparatus of claim 24, wherein the multifunctional nanorod comprises at least one of the following functions:
adhesion functions;
mechanical functions;
thermal functions;
electrical functions;
conduction functions; and
optical functions.

26. The apparatus of claim 24, wherein specific material layers of the nanorod are selectively functionalized.

27. The apparatus of claim 26, wherein selective functionalization forms at least one of a chemical bridge and a mechanical bridge between individual nanorods.
